(19) United States
(12) Patent Application Publication
(10) Pub. No.: US 2026/0241496 A1
(43) Pub. Date: Aug. 20, 2026

(54) WATER-FREE PRINTABLE FLUX COMPOSITION AND METHOD OF MAKING

(71) Applicant: Solstice Advanced Materials US, Inc., Morris Plains, NJ (US)

(72) Inventors: Liu Xufeng, Shanghai (CN); Fei Zhou, Shanghai (CN); Alfred Siggel, Seelze (DE); Jurgen Rudolph, Peine (DE)

(73) Assignee: Solstice Advanced Materials US, Inc., Morris Plains, NJ (US)

(21) Appl. No.: 19/459,069

(22) Filed: Jan. 26, 2026

Related U.S. Application Data
(60) Provisional application No. 63/760,661, filed on Feb. 20, 2025.

(51) Int. Cl. B23K 35/36; B23K 35/365; B23K 103/10

(52) U.S. Cl. CPC B23K 35/361; B23K 35/365; B23K 2103/10

(57) ABSTRACT

Compositions are provided that are useful in brazing applications and associated brazing methods. More particularly the present disclosure relates to a water-free solvent-type cleaning-free printable flux composition that includes a flux, binders, and solvents. The flux paste can be used to braze or solder, for example, extended flat plate coolers used in high performance lithium batteries used for example, in electrically powered cars.

### CROSS REFERENCE TO RELATED APPLICATION

This application claims the benefit of U.S. Provisional Application No. 63/760,661 filed Feb. 20, 2025.

### TECHNICAL FIELD

The present disclosure generally relates to materials useful for brazing applications and associated brazing methods. More particularly the present disclosure relates to a water-free solvent-type cleaning-free printable flux paste. The flux paste can be used to braze or join, for example, extended flat plate coolers used in high performance lithium batteries used in electrically powered cars.

### BACKGROUND

High performance of modern lithium batteries in electrically powered cars requires very effective heat exchangers and cooling systems to dissipate the heat generated during rapid discharging or brief charging. For this purpose, extended flat plate coolers made of aluminum are usually used, which are joined together by brazing.

Brazing requires a flux that is applied with high precision only in the contact zones of the plate heat exchanger, e.g., by high-frequency printing, pyrolyzes residue-free during brazing and contains no water as a component. In practice, it has been shown that water vapor from the flux formulation can only escape very poorly or not at all from the inside of the plate heat exchanger and leads to corrosion of the inner aluminum surfaces even before the cooling element is installed and filled.

Although the no-clean flux does not imply that no residue is present, the residue of the no-clean flux contains various types of resin, solvents, and acidic species, and many of studies have shown that the use of no-clean flux leads to issues of reduced reliability of the weld as a function of temperature change.

Accordingly, it is desirable to develop printable flux pastes that provide for a water-free, no clean formulation for long term printing, leaves no carbon residues, and is non-corrosive. In addition, it is desirable to provide a composition that does not solidify when used with cesium based flux, reduced or no clogging of nozzles or nozzle drying, has slow sedimentation, is safe handling, and has excellent adhesion to aluminum. Furthermore, other desirable features and characteristics of the present disclosure will become apparent from the subsequent detailed description and the appended claims, taken in conjunction with the accompanying drawings and this background.

### BRIEF SUMMARY

Provided is a water-free, no-clean brazing composition. More particularly, the composition includes a fluxing agent independently chosen from potassium fluoroaluminate (KAlF₄), cesium tetrafluoroaluminate (CsAlF₄), and combinations thereof, one or more binders, and one or more solvents.

Also provided is a method for producing a brazing compound. More particularly, the method comprises micronizing a brazing composition that includes a fluxing agent independently chosen from potassium fluoroaluminate (KAlF₄), cesium tetrafluoroaluminate (CsAlF₄), and combinations thereof, one or more binders, and one or more solvents. The solid particles of the composition are ground to a particular viscosity and particle size to form the micronized composition.

Finally, provided is a method of brazing metal substrates. The method includes micronizing the solid particles of the brazing composition to a D99 particle size of less than 60 microns; and a viscosity of from about 2000 mPas to about 8000 mPas, or from about 4000 mPas to about 6500 mPas. The composition can be used to braze or solder a first metal substrate to a second metal substrate.

### BRIEF DESCRIPTION OF THE DRAWINGS

The present disclosure will hereinafter be described in conjunction with the following drawing figures, wherein like numerals denote like elements, and wherein:

FIG. 1, shows the optimal viscosity of the brazing composition;

FIG. 2, shows the effects of low viscosity of the brazing composition;

FIG. 3, shows the effects of the clogging of a printer nozzle that occurs with high viscosity paste;

FIG. 4, shows desired and undesired brazing compositions under controlled atmosphere brazing (CAB); and

FIG. 5, shows the thixotropic behavior of high and low viscosity printing paste.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Unless specifically stated or obvious from context, as used herein, the term “about” is understood to mean within a range of normal tolerance in the art, for example within 2 standard deviations of the mean. “About” can be understood to mean within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

Provided are compositions and methods of producing a new printable, solvent-type clean-free flux paste. In particular, the present formulation provides for a printable composition having certain particle size and viscosity parameters, which prevents nozzle blockage and slow sedimentation rates. In addition, the present formulation provides long open time of the composition, which also prevents nozzle clogging. The composition also provides for a no-cleaning, wash free composition the has no black residue after brazing metal substrates together. Finally, the present formulation provides for a water-free or no-water composition, which prevents corrosion from taking place inside the brazed parts.

In some aspects of the present composition, the composition contains a flux agent independently chosen from potassium fluoroaluminate (KAlF₄), cesium tetrafluoroaluminate (CsAlF₄), and combinations thereof; one or more binders; and one or more solvents.

In some aspects of the composition, the flux agent(s) is present in an amount of from about 30 wt. % to about 65 wt. %, or from about 40 wt. % to about 60 wt. %.

In some aspects of the composition, the one or more binders can be chosen from monomers of polyacrylic resins, polyester resins, epoxy resins, alkyd resins, phenolic resin, amino resin, polyurethane resin, organosilicon resin, polyester polyols, polyether polyols, polycarbonate, polycarbonate polyols and combinations thereof.

In other aspects of the composition, the monomers of polyacrylic resins can be chosen from acrylic acid (AA), methacrylic acid (MAA), methyl methacrylate (MMA), butyl acrylate (BA), hexyl acrylate (HA), and combinations thereof.

In some aspects of the composition, the one or more binders are present in an amount of from about 0.1 wt. % to about 70 wt. %, or from about 0.5 wt. % to about 60 wt. %.

In some aspects of the composition, the solvent can be any water-free solvent. Although low boiling point solvents can be used it was found that solvents having boiling point temperatures above 150° C., high flashpoints of 60° C., and low evaporation rates of less than 1 were found to provide the best results.

In some aspects of the composition, the one or more solvents can be an ester, alcohol, aromatic, ketone, aliphatic solvent, ester alcohol, ether alcohol or a dibasic ester and combinations thereof.

In some aspects of the composition, the one or more solvents is chosen from 2,2,4-trimethyl-1,3-pentanediolmono(2-methylpropanoate), triethylene glycol monobutyl ether, propylene carbonate, propylene glycol, diethylene glycol monobutyl ether acetate and combinations thereof.

In some aspects of the composition, the one or more solvents is present in an amount of from 1 wt. % to about 65 wt. %, or from about 3 wt. % to about 60 wt. %, and can be from about 5 wt. % to about 50 wt. % of the total composition.

In some aspects of the composition, the composition further comprises a dispersing agent chosen from non-ionic and anionic surfactants (including alcohol ethoxylates, alkylphenol ethoxylates, fatty acid ethoxylates, sorbitan esters and their ethoxylates, amine ethoxylates, block copolymers etc.), fatty acids, phosphate esters, hyperbranched polyamines, polymeric dispersants, polyurethanes, polyacrylics, comb-type hyperdispersants such as those used for the dispersion of liquid dispersed dyes (LDDs), multi-functional comb-type polymers such as those that have ionic groups on the main chain grafted with polyoxyalkylene chains, copolymers of ethylene and acrylic acid (EAA), styrene maleic anhydride (SMA) resins, and combinations thereof.

The comb-like polymers have shown superior performance in dispersing and stabilizing colloidal suspensions. They are constituted of a carboxylate backbone which is believed mainly responsible for polymer adsorption and colloidal stabilization due to electrostatic interactions; and poly(ethoxy) side chains responsible for steric hindrance stabilization.

In some aspects of the composition, the dispersing agent can be present in an amount of from about 0.1 wt % to about 10 wt. %, or from about 0.5 wt. % to about 5.0 wt. %.

In micronizing the composition, the particle size of the composition is not particularly limited except as described below relative to chemistry and general particle size. In various embodiments, the composition includes or is a series of particles. The particles may have a Dv10, Dv50, Dv99, Dn10, Dn50, and/or Dn99 particle size in which the Dn99 is described below.

In some embodiments, the Dn99 is less than about 60 μm, or less than about 55 μm, or less than about 50 μm, or may be less than about 20 μm as determined using one or more methods such as ASTM D5861, ISO 13320:2009, ISO 13320:2020, or the like.

Moreover, the particle size may be determined using any apparatus known in the art, e.g., a HORIBA LA 960 particle size analyzer. Relative to software version, type of light scattering model applied, real and imaginary part of complex refractory index if Mie theory is applied, refractive index, sampling procedure, amount and power of ultrasound, etc. can each be chosen by one of skill in the art if not set forth in the aforementioned standard procedures. The powder also typically includes a weight percent of water (e.g., as absorbed from the atmosphere of less than about 10, 9, 8, 7, 6, 5, 4, 3, 2, 1, 0.5, or 0.1, weight percent based on a total weight of the powder. In various non-limiting embodiments, all values and ranges of values, both whole and fractional, both between and including each of the above, are hereby expressly contemplated for use herein.

In some aspects of the composition, the micronized composition has a viscosity of from about 2000 mPas to about 8000 mPas, or from about 4000 mPas to about 6500 mPas as measured by a Haake Viscotester IQ rotational viscometer. When the viscosity of the composition is too low or too high, undesirable results occur as discussed below.

Also provided is a method of producing a brazing compound that includes providing composition containing a flux agent independently chosen from potassium fluoroaluminate (KAlF₄), cesium tetrafluoroaluminate (CsAlF₄), and combinations thereof; one or more binders; and one or more solvents. The solid particles of the composition are micronized by grinding the composition until a desired viscosity and particle size distribution is reached.

The grinding process can be any process capable of comminuting solids in a liquid, e.g., wet grinding. Wet grinding is used in many branches of industry, such as the chemical, food, and pharmaceutical industries. Wet grinding produces a fine suspension or emulsion in which the particle size of the solids is reduced.

Various formulas are used to calculate the efficiency of wet grinding. One parameter in producing the desired particle size distribution is the specific energy required to grind a certain amount of solids. The specific energy can be calculated using the following formula:

$$E = ( P * t ) / m ,$$

where P is the power used in watts, t is the grinding time in seconds and m is the quantity of solids ground in kilograms.

Another variable in producing the desired particle size is the grinding time, which indicates how many solids can be ground per unit of time. The grinding time can be calculated using the following formula:

$$Q = m / t ,$$

where Q is the specific grinding time in kilograms per second, m is the quantity of solids ground in kilograms and t is the grinding time in seconds.

In some aspects of the method, all components of the composition decompose to more than 99 wt. %, or from 99.5 wt. % to 100 wt. %, when the temperature of the composition reaches from about 100° C. to about 700° C. Decomposition starts at a certain temperature, than rapidly decomposes. For example, when the temperature increases, the solvent will begin to evaporate, and the binder will decompose gradually after a certain temperature is reached.

Finally, provided is a method of brazing metal substrates that includes providing a brazing composition containing a flux agent independently chosen from potassium fluoroaluminate (KAlF₄), cesium tetrafluoroaluminate (CsAlF₄), and combinations thereof; one or more binders; and one or more solvents. The brazing composition is micronized forming a micronized paste having a D99 particle size of less than about 60 microns; and a viscosity of from about 2000 mPas to about 8000 mPas, or from about 4000 mPas to about 6500 mPas as measured by a Haake Viscotester IQ rotational viscometer using a FL 100 rotor at a shear rate of 23.5 rpm for 30 seconds.

Using the micronized brazing composition, a first metal substrate and a second metal substrate can be joined or soldered together using the composition by brazing the first metal substrate to the second metal substrate.

In some aspects of the method, the first and/or second metal substrates are independently selected from aluminum, aluminum alloy, aluminum-magnesium alloy, and combinations thereof.

In some aspects of the method, the step of brazing is accomplished using a printer or a robot arm and a printer.

In other aspects of the method, the method further comprises the step of printing the brazing composition on a first metal substrate and wherein the step of brazing is further defined as brazing the first metal substrate to the second metal substrate to form a mechanical part for one or more of car bodies, battery packs, fuel cells, condensers, gas coolers, evaporators, heaters, radiators, oil coolers, fuel coolers, exhaust gas recirculation systems, charge air coolers, heat exchangers for photovoltaic elements, heat exchangers for solar heat collectors, and evaporators.

### EXAMPLES

The following studies were done comparing the currently developed brazing formulations with typical brazing formulations currently used in flat plate cooler applications. The brazing composition was studied for long term printing, brazing or no brazing residue, non-corrosiveness, safety in handling, solidification with cesium flux (if used), whether there was clogging or nozzle drying, sedimentation of the composition, and the adhesion to aluminum.

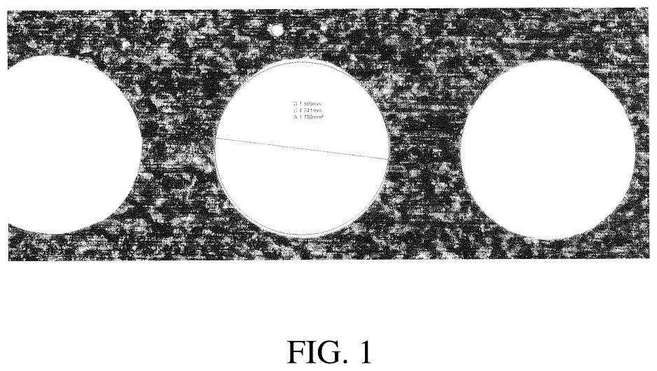

The effects of optimal viscosity can be seen in FIG. 1, which shows the optimal viscosity, as measured by a Haake Viscotester IQ rotational viscometer, of the composition.

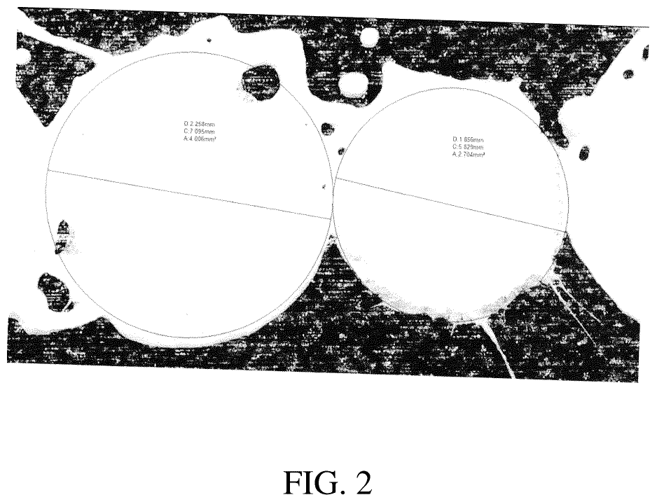

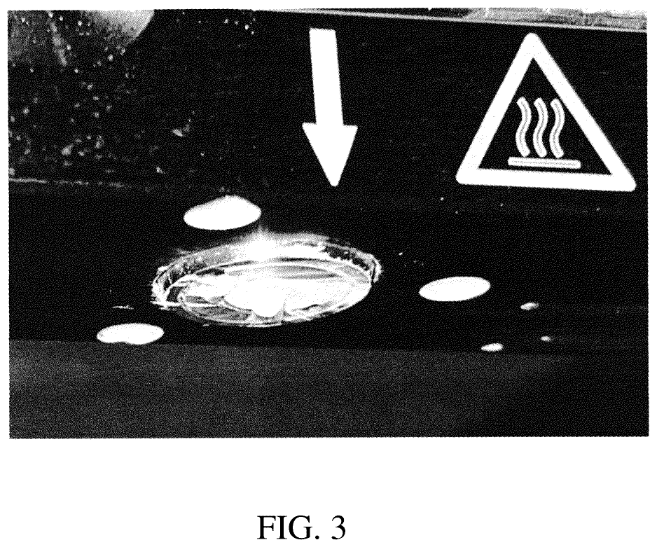

The solvent content of the composition is adjusted to have the proper viscosity. When the viscosity of the composition is too low or too high, undesirable results occur such as splatter and nozzle clogging (see FIG. 2 and FIG. 3).

### Preparation of the Brazing Composition

Compositions were prepared as described in Table 1. The following general procedure was used in preparing the composition for testing. In the first step of the process the solvent was added to a high speed dispersion (HSD) mixer followed by the binder(s) and optional dispersant and mixed for about 20 to 30 minutes ensuring uniform mixing. In a second step, the KAlF₄ was added to the mixture and the mixture was mixed for an additional 20 to 30 minutes ensuring uniform mixing. In a third step, the mixture was micronized through grinding, as described below, until the desired particle size was obtained.

### Micronization of the Composition

Once the compositions were prepared, 6 kilograms of the compositions were fed to a Netzsch wet mill rotating disk grinder (NETZSCH-Feinmahltechnik GmbH) and the solid particles of the compositions were ground at a bead size of 2000 microns and a milling speed of 2000 rpm for about 20 to 30 minutes, with a targeted D99 particles size of less than 20 microns as measured on a HORIBA LA 960 particle size analyzer.

Viscosities were measured by a Haake™ Viscotester™ IQ rotational viscometer using a FL 100 rotor; shear rate of 23.5 rpm; for 30 seconds. The compositions typically had viscosities starting at about 6600 mPas and decreased to about 5200 mPas.

The formulations were analyzed for their long term printing; whether a brazing residue was observed; the non-corrosiveness of the formulations; safe handling; solidification with cesium flux; whether there was nozzle clogging or drying; sedimentation rate; and the adhesion to aluminum.

TABLE 1
Chemical Formulations for Examples 1-9

| | Example | | | | | | | | |
|---|---|---|---|---|---|---|---|---|---|
| | 1 | 2 | 3 | 4 | 5 | 6 | 7 | 8 | 9 |
| | (%) | (%) | (%) | (%) | (%) | (%) | (%) | (%) | (%) |
| KAlF4 | 45 | 45 | 30 | 34 | 45 | 45 | 45 | 50 | 50 |
| CsAlF4 | | | 10 | 11 | | | | | |
| Polyacrylic | 2 | | | | 0 | 2 | 2 | 2 | |
| binder-#1 | | | | | | | | | |
| Acrylic binder | | 2 | | | | | | | |
| Polyvinyl butyral - | | | | | 2 | | | | 2 |
| binder | | | | | | | | | |
| Polyethylene | 1 | 1 | 1 | | 1 | 1 | 1 | 1 | 1 |
| oxide dispersant | | | | | | | | | |
| Propylene | | | | 55 | | | | | |
| glycol solvent | | | | | | | | | |
| Methyl n-amyl | | | | | | | | 5 | |
| ketone | | | | | | | | | |
| 3-methoxy-3- | | | | | | | 48 | | |
| methyl-1- | | | | | | | | | |
| butanol solvent | | | | | | | | | |
| 1-Octanol solvent | | | 5 | | | | | | |
| Hydrocarbon | | | 5 | | | | 2 | 40 | |
| solvent | | | | | | | | | |
| Polycarbonate | | | 49 | | | | | | |
| polyol - #1 | | | | | | | | | |
| Polycarbonate | 2 | 2 | | | 2 | 2 | | | 2 |
| polyol - #2 | | | | | | | | | |
| (3-hydroxy-2,2,4- | 50 | 50 | | | 50 | 49 | | | 45 |
| trimethylpentyl | | | | | | | | | |
| 2-methylpropanoate) | | | | | | | | | |
| solvent | | | | | | | | | |
| THIXATROL ® PM 8056 | | | | | | | 2 | 2 | |
| (additive) | | | | | | | | | |

Examples 1, 2, 3, and 6 showed excellent results in each category. Examples 4, 5, 7, 8, and 9, each showed deficiencies in at least one of the categories outlined above.

### Example 1—Reference

A reference composition was prepared by mixing a solution of 3000 grams (g) of 3-hydroxy-2,2,4-trimethylpentyl 2-methylpropanoate, a solution of 120 g methacrylate copolymer binder, 120 g of a polycarbonate polyol-#2, and 60 g polyethylene oxide dispersant to a circulation tank of the Netzsch wet mill and circulation begun. The mixture was circulated through the mill and 2,700 g of KAlF4 was added to the mixture over about a 10 minute time period at 1200 revolutions per minute (r/min) and milled for 60 minutes at 2,000 r/min. The resulting flux paste is very fine-grained, creamy with a viscosity of between 3000 and 6000 mPas and can be printed without any problems. All organic components pyrolyze or evaporate residue-free at 200 to 600° C. and the flux part ensures a clean solder seam.

### Example 2—Alternate Binder

The same procedure used in example 1, 120 g of methacrylic acid ester copolymer was used as the binder. Results indicated that the paste obtained with this binder can be printed with very little issue. Although the binder left a few carbon particles we were still able to obtain desirable results.

### Example 3—Flux Blends

In this example, the polycarbonate polyol-#2 was replaced with a different polycarbonate polyol-#1. In addition to the KAlF4 flux, CsAlF4 flux was added to the composition.

A mixture of 2,940 g of polycarbonate polyol-#1, 300 g hydrocarbon solvent, 300 g 1-octanol, and 60 g dispersant was added to the circulation tank of the Netzsch mill. 2,400 g of a mixed blend of the KAlF₄/CsAlF₄, flux was added to the mixture over about a 10 minute time period and milled for 60 minutes at 2,000 r/min.

Results indicated that the composition exhibited good shelf life and showed little reactivity with the CsAlF₄ flux. If the cesium flux has reacted with the liquid organic components of the formulation, a solidification of the paste can be observed in the worst case. In some cases, however, only a strong increase in viscosity was observed after two weeks at 50° C. This could initially be determined by a simple stirring test with a spatula. If an increase in viscosity was observed, the viscosity was determined in a second step using a rotational viscometer as described above.

### Example 4—Alternate Solvent

In this example, the polycarbonate polyol-#1 was replaced with 1,2-propylene glycol. The same process as described above was used. 3,300 g of 1,2-propylene glycol was placed in the circulation tank of the Netzsch mill and 2,700 g of a blend of KAlF4/CsAlF4 flux (2,025 g/675 g, respectively) was added to the milling process over a 10 minute time period, followed by milling for 60 minutes using the conditions mentioned in examples 1-3.

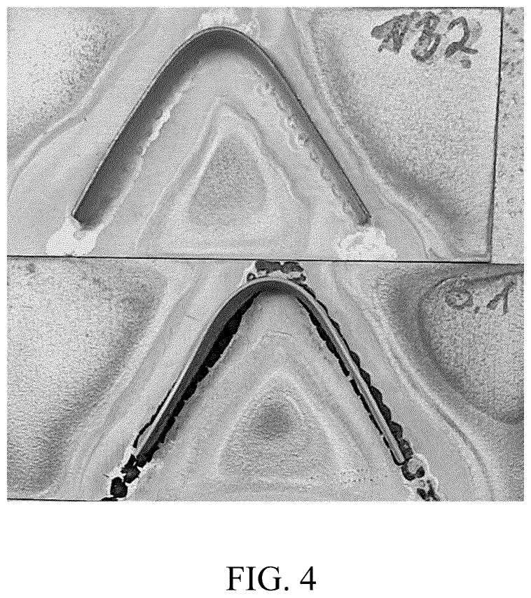

Results showed that the glycol solvent causes a black residue on aluminum alloys when brazed (see FIG. 4). However, it was also found that the composition has a long shelf life and shows no signs of solidification with a KAlF₄/CsAlF₄ flux blend.

### Example 5—Alternate Binder

The procedure outlined in Example 1, was used here, except that a polyvinyl butyral (PVB) was used instead of the methacrylate copolymer binder.

The formulation with the organic binder PVB does not provide the desired results. The PVB does not pyrolyze completely and leaves behind black soot residues.

### Example 6—Additional Dispersant

The same general procedure used in the previous examples were used here. In addition to the polyethylene oxide dispersant, a second polymeric dispersant was added to the formulation and a simple sedimentation test was performed.

In this example, 2,940 g of 3-hydroxy-2,2,4-trimethylpentyl 2-methylpropanoate solvent was used, 120 g binder, 120 g polycarbonate polyol-#2, 60 g polyethylene oxide dispersant, and 60 g of the polymeric dispersant.

Sedimentation tests indicated that the second dispersant slows down the sedimentation rate and provides a longer shelf life than the reference composition.

### Example 7—Rheology Additive

The same procedures as described above was used here except that the solvent was 3-methoxy-3-methyl-butanol, and a diamide copolymer rheology additive was added to the composition.

2,880 g of solvent, 120 g of methacrylate copolymer binder, 120 g dearomatized hydrocarbon and 60 g dispersant were added to circulation tank of a Netzsch mill and circulation through the mill began. 120 g of the diamide rheology additive was added to the circulation tank and circulated until the additive was dissolved (10-20 minutes) followed by the addition of 2,700 g of KAlF₄ flux powder over 10 minutes and a circulation rate of 1,200 r/min. Milling was continued for 60 minutes at 2,000 r/min.

The composition showed rapid drying and did not allow sequential printing. Nozzle blockage was observed and required regular nozzle cleaning.

### Example 8—Alternate Solvent

The same procedure used in Example 1 was used here except that the solvent was a hydrocarbon solvent.

### Example 9—Alternate Binder

In this example a polyvinyl butyral binder was used in the formulation.

### Examples 10-16

The same process and procedures as used in Examples 1-9, i.e., addition time and circulation conditions for milling the composition, were used in Examples 10-16, formulations of which can be found in Table 2.

TABLE 2
Chemical Formulations for Examples 10-16

| | Example | | | | | | |
|---|---|---|---|---|---|---|---|
| | 10 | 11 | 12 | 13 | 14 | 15 | 16 |
| | (%) | (%) | (%) | (%) | (%) | (%) | (%) |
| KAlF4 | 30 | 37.5 | 37.5 | 37.5 | 37.5 | 37.5 | 37.5 |
| CsAlF4 | 10 | 12.5 | 12.5 | 12.5 | 12.5 | 12.5 | 12.5 |
| Polycarbonate | 50 | 25 | | | | | |
| polyol - #1 | | | | | | | |
| 1-Octanol | 10 | | | | | | |
| Triethylene | | 25 | 50 | | | | |
| Glycol | | | | | | | |
| Oleic Acid | | | | 50 | | | |
| 2,2,4-Trimethyl- | | | | | 50 | | |
| 1,3-pentanediol | | | | | | | |
| monoisobutyrate | | | | | | | |
| Triethylene | | | | | | 50 | |
| glycol | | | | | | | |
| monobutyl ether | | | | | | | |
| Dearomatized | | | | | | | 50 |
| Hydrocarbons | | | | | | | |
| D100 | | | | | | | |

### Example 10-Solvent Blends

In this example, the solvent was a mixture of 3,000 g of Polycarbonate polyol-#1 and 600 g of 1-Octonaol, which was added to the circulation tank of the Netzsch mill and circulation begun. 2,400 g of a KAlF4/CsAlF4 flux blend (1,800 g/600 g, respectively) was added to the circulation tank and milled for the times and conditions used in Examples 1-9.

The composition was found to have good oven stability and long shelf life. Solidification of the composition was not an issue after a long term oven stability test. The composition also displayed good printing properties, and no black residue was observed after brazing aluminum alloys.

Although not to be bound by theory, it appears that the cesium flux reacts with the liquid organic components of the formulation and a solidification of the paste can occur. Oven stability tests are performed by observing an increase in viscosity after two weeks at 50° C. This was initially determined by a simple stirring test with a spatula. If an increase in viscosity was observed, the viscosity was determined in a second step using a rotational viscometer. Shelf life is determined by observation for no less than 6 months. Printing properties means the print dots are uniform for long term printing and no nozzle clogging after printing.

### Example 11—Solvent Blends

In this example, the solvent was a mixture of 1,500 g of Polycarbonate polyol-#1 and 1500 g of triethylene glycol, which was added to the circulation tank of the Netzsch mill and circulation through the mill begun. 3000 g of a KAlF4/CsAlF4 flux blend (2250 g/1750 g, respectively) was added under the times and conditions used in Examples 1-10.

The composition was found to have good oven stability, long shelf life, good print properties, and no black residue was observed after brazing aluminum alloys (See FIG. 4). However, this formulation was found to corrode the aluminum substrate if the time between printing and brazing is too long, e.g., longer than 8 hours at room temperature.

For example, and not to be bound by theory, surface coolers for battery elements are up to 1 square meter in size and consist of two shaped aluminum sheets with only one inlet and outlet of small diameter. Water formed during soldering or trapped water escapes with difficulty and leads to the formation of aluminum oxide inside the cooler. However, the corrosion takes place after the soldering process in the finished component and corrosion can occur inside the cooler, which reduces the circulation of the coolant and thus the effectiveness of the cooler.

### Example 12—Triethylene Glycol Solvent

In this example, a solution containing 3,000 g triethylene glycol was added to the Netzsch circulation tank and 3,000 g of a KAlF4/CsAlF4 flux blend (2250 g/750 g, respectively) was added under the times and conditions used in Examples 1-11.

The composition showed good oven stability and long shelf life and does not have solidification issues after a long term oven stability test. However, some separation of the composition was observed after long term storage. The storage test is accomplished at elevated temperatures, roughly about 30° C. above room temperature, as a stability test. Preliminary tests have shown that a storage time of 2 weeks corresponds to a shelf life of about 6 months in a closed container.

### Example 13—Oleic Acid Solvent

The same process and procedures were followed as in Example 12, except the triethylene glycol was replaced with 3,000 g oleic acid.

As with Example 12, results showed good oven stability and long shelf life and does not have solidification issues after a long term oven stability test. However, the viscosity is very low, there was observed some separation of the composition after long term storage. In addition, there was observed a black residue (See FIG. 4) after the brazing test described below.

### Example 14—2,2,4-Trimethyl-1,3-pentanediol monoisobutyrate Solvent

The same process and procedures were followed as in Example 12, except the triethylene glycol was replaced with 3,000 g of 2,2,4-trimethyl-1,3-pentanediol monoisobutyrate.

The composition showed poor oven stability and solidified after a long term oven stability test.

### Example 15—Triethylene Glycol Monobutyl Ether Solvent

The same process and procedures were followed as in Example 12, except the triethylene glycol was replaced with 3,000 g of triethylene glycol monobutyl ether as the solvent.

As with the 2,2,4-trimethyl-1,3-pentanediol monoisobutyrate, the composition using triethylene glycol monobutyl ether, showed poor oven stability and solidified after a long term oven stability test.

### Example 16—Dearomatized Hydrocarbon Solvent

The same process and procedures were followed as in Example 12, except the triethylene glycol was replaced with 3,000 g of dearomatized Hydrocarbon D 100 as the solvent.

As with Examples 14 and 15, the composition using dearomatized Hydrocarbon D 100 as the solvent, poor oven stability was observed and the composition solidified after a long term oven stability test was performed.

### Example 17—Brazing Tests

Print test studies were done comparing currently developed brazing formulations with typical brazing formulations currently used in flat plate cooler applications. The brazing was done on a pure aluminum substrate AA3003 (MP 654° C.) and a piece of cladded aluminum sheet (4343 MP 610° C.) in the shape of a “V”. The brazing composition was applied with a Nordson printer and a Dot diameter of 1.3 millimeters (mm) and a Dot distance of 2.0 mm.

Brazing was done in a glass oven under controlled atmosphere brazing (CAB) with a heat up rate of 20 Kelvin (K)/minute; a cooling rate of 20 K/minute; a N2 flow of 3 ml/min; and a Tmax of 620° C.

The formulations described in Examples 1-16, were tested for their brazing qualities (a clean white residue vs a black residue after brazing with aluminum alloys) using the procedure described above. Examples 1, 2, 3, and 6, 10, and 11, showed the desired results (see FIG. 4. for an example of desired brazing and undesirable brazing results).

### Example 18—Print Tests

A Pico Pulse Jetter with a 300 micron nozzle 5.03-030, with Pico Touch Controller was used in the Print testing using the following parameters: Open time 0.20 millisecond (ms); Close time 0.25 ms; Pulse time 1.0 ms; Cycle time 30.0 ms; Open volts 100 V; Stroke 90%; Speed 100 meters/minute; Distance 5000 micron; Pressure 4.0 bar.

### 3-Step Shear Rate/Thixotropy Test

Compositions were prepared having a high viscosity (over 6,000 mPas) and a low viscosity (under 6,000 mPas) solvent borne paste (NB2) and tested.

Samples were tested in 3-Step shear recovery experiments found in many references, e.g., TA instruments “Introduction to Thixotropy Analysis Using a Rotational Rheometer. The thixotropic behavior of the compositions was determined using the commonly used 3-step process, i.e., Step 1: Rotor—FL100, low shear, 0.1 1/second (Vs) for 60 seconds at a temperature of 22° C.; Step 2: high shear, 10 Vs for 30 seconds at temperature 22° C.; and Step 3: low shear, 0.1 Vs for 180 seconds at temperature 22° C. Sampling for Steps 1 and 2 were done at 1 second intervals. Step 3 sampling was every 2 seconds.

A Controlled Rate (CR) ramp from low to high shear rates, followed by a steady shear rate element at the highest shear rate and a CR ramp back to the low shear rate.

The behavior of high and low viscosity printing paste was observed in dynamic viscosity measurements. The recovery of the micro-structure of high viscosity paste after high shear stress takes a much longer time as can be seen from a 3-step curve measurement.

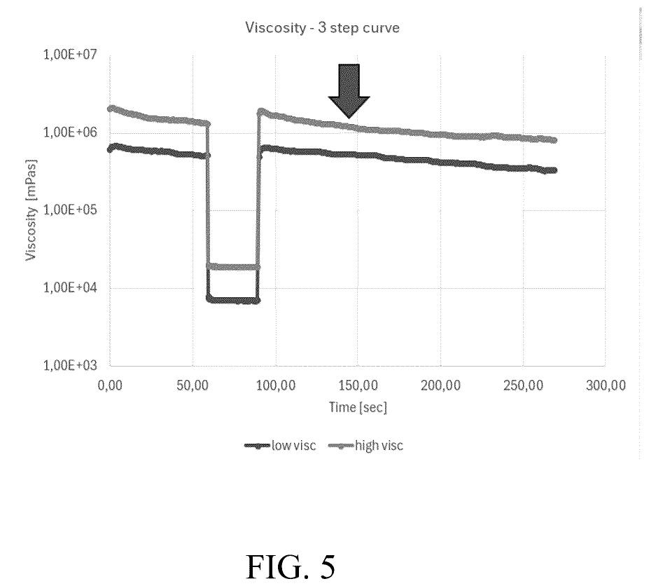

Results of the 3-Step test as shown in FIG. 5, indicated that the low viscosity paste showed the quickest recovery (for the paste to recover to its initial viscosity), and the lowest overall viscosity in the first step. Even though the selected shear rate is considered low, the material cannot be considered at rest, due to the continuous shear in CR-mode. The recovery of the high viscous paste is more delayed and more time-dependent after being stressed at 10 s−1. Results also indicated that it takes more than 60 seconds for the high viscosity paste to recover the initial viscosity after being stressed. In practice the paste cannot flow fast enough to fill the void in the printer nozzle, or the back pressure is too high to form a drop that can be ejected and thus clogging of the nozzle can occur.

At least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

1. A brazing composition comprising:
a flux agent independently chosen from potassium fluoroaluminate (KAlF4), cesium tetrafluoroaluminate (CsAlF4), and combinations thereof;
one or more binders; and
one or more solvents.

2. The composition according to claim 1, wherein the flux agent is present in an amount of from about 30 wt. % to about 65 wt. %, or from about 40 wt. % to about 60 wt. %.

3. The composition according to claim 1, wherein the one or more binders are chosen from monomers of polyacrylic resins, polyester resins, epoxy resins, alkyd resins, phenolic resin, amino resin, polyurethane resin, organosilicone resin, polyester polyols, polyether polyols, polycarbonate, polycarbonate polyols, and combinations thereof.

4. The composition according to claim 3, wherein the monomers of polyacrylic acid resin are chosen from an acrylic acid (AA), methacrylic acid (MAA), methyl methacrylate (MMA), butyl acrylate (BA), hexyl acrylate (HA), and combinations thereof.

5. The composition according to claim 1, wherein the one or more binders are present in an amount of from about 0.1 wt % to about 70 wt. %, or from about 0.5 wt. % to about 60 wt. %.

6. The composition according to claim 1, further comprises a dispersing agent chosen from non-ionic and anionic surfactants chosen from alcohol ethoxylates, alkylphenol ethoxylates, fatty acid ethoxylates, sorbitan esters and their ethoxylates, amine ethoxylates, block copolymers, fatty acids, phosphate esters, hyperbranched polyamines, polymeric dispersants, polyurethanes, polyacrylic, comb-like hyperdispersants, multi-functional comb type polymers, ethylene and acrylic acid copolymers, styrene maleic anhydride resins, and combinations thereof.

7. The composition according to claim 6, wherein the dispersing agent is present in an amount of from about 0.1 wt % to about 10 wt. %, or from about 0.5 wt. % to about 5.0 wt. %.

8. The composition according to claim 1, wherein the solvent is chosen from esters, alcohols, hydrocarbon aromatics, ketones, aliphatic solvents, ester alcohols, ether alcohol, dibasic esters, and combinations thereof.

9. The composition according to claim 8, wherein the solvent is chosen from 2,2,4-trimethyl-1,3-pentanediolmono(2-methylpropanoate), triethylene glycol monobutyl ether, propylene carbonate, propylene glycol, diethylene glycol monobutyl ether acetate, and combinations thereof.

10. The composition according to claim 1, wherein the solvent is present in an amount of from 1 wt. % to about 65 wt. %, or from about 3 wt. % to about 60 wt. %.

11. The composition according to claim 1, wherein the D99 particle size distribution of the formulation is less than about 60 microns, or less than about 50 microns, and can be less than about 20 microns as determined by laser diffraction based on Mie scattering.

12. The composition according to claim 1, wherein the viscosity of the formulation is from about 2000 mPas to about 8000 mPas, or from about 4000 mPas to about 6500 mPas as measured by a Haake Viscotester IQ rotational viscometer.

13. A method of producing a brazing compound comprising:
providing a composition according to claim 1;
grinding the composition to a particular viscosity and particle size to form a micronized composition.

14. The method according to claim 13, wherein all components of the composition decompose to more than 99 wt. % when heated to a temperature of about from 100° C. to about 700° C.

15. The method according to claim 13, wherein the micronized composition has a viscosity of from about 2000 mPas to about 8000 mPas or from about 3000 mPas to about 6500 mPas; and the D99 particle size is less than about 60 micron.

16. A method of brazing metal substrates comprising:
providing a brazing composition according to claim 1,
micronizing the solid particles of the brazing composition to a D99 particle size of less than 60 microns; and a viscosity of from about 2000 mPas to about 8000 mPas;
providing a first metal substrate and a second metal substrate;
brazing the first metal substrate to the second metal substrate using the micronized composition.

17. The method according to claim 16, wherein the first and/or second metal substrates independently comprise aluminum, aluminum alloy, aluminum-magnesium alloy, and combinations thereof.

18. The method according to claim 16, wherein the step of brazing is accomplished using a printer or a robot arm and a printer.

19. The method according to claim 16, further comprising the step of printing the brazing composition on the first metal substrate and wherein the step of brazing is further defined as brazing the first metal substrate to the second metal substrate to form a mechanical part for one or more of car bodies, battery packs, fuel cells, condensers, gas coolers, evaporators, heaters, radiators, oil coolers, fuel coolers, exhaust gas recirculation systems, charge air coolers, heat exchangers for photovoltaic elements, heat exchangers for solar heat collectors, and evaporators.
